(19) United States
(12) Patent Application Publication
(10) Pub. No.: US 2008/0172520 A1
(43) Pub. Date: Jul. 17, 2008

(54) NONVOLATILE MEMORY DEVICES INCLUDING MULTIPLE USER-SELECTABLE PROGRAM MODES AND RELATED METHODS OF OPERATION

(75) Inventor: Bong-Ryeol Lee, Seoul (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/838,348

(22) Filed: Aug. 14, 2007

(30) Foreign Application Priority Data
Jan. 17, 2007 (KR) 10-2007-0005252

(51) Int. Cl. G06F 12/00

(52) U.S. Cl. 711/103; 711/E12.001

(57) ABSTRACT

A memory device includes a flash memory, a memory controller, and an MLC mode selector. The flash memory includes at least one memory cell configured to store multi-bit data therein. The MLC mode selector is configured to generate a mode selection signal indicating whether to store single-bit data or multi-bit data in the memory cell responsive to a user selection. The memory controller is configured to operate the flash memory in a single-level cell (SLC) program mode to store the single-bit data or a multi-level cell (MLC) program mode to store the multi-bit data based on the mode selection signal from the MLC mode selector. The memory device may be configured to store program mode information for the memory cell indicating whether the single-bit data or the multi-bit data is stored therein. Related systems and methods of operation are also discussed.

### CROSS-REFERENCE TO RELATED APPLICATIONS

This application claims priority under 35 U.S.C. § 119 from Korean Patent Application No. 10-2007-05252 filed on Jan. 17, 2007, the disclosure of which is hereby incorporated by reference herein in its entirety.

### FIELD OF THE INVENTION

The present invention relates to the field electronics, and more particularly, to electronic memory systems and.

### BACKGROUND OF THE INVENTION

Portable apparatuses employing nonvolatile memories may be increasingly common. For example, nonvolatile memories may be used as storage units in MP3 players, digital cameras, mobile phones, camcorders, flash cards, solid state disks (SSDs), and so on.

As the use of nonvolatile memory-based storage units increases, memory capacities may also increase. One way to increase memory capacity may involve a multi-level cell (MLC) mode that may store multiple data bits in a unit memory cell.

FIG. 1 is a block diagram of a conventional memory system. Referring to FIG. 1, the memory system 100 may include a host 110, a memory controller 120, and a flash memory 130.

The memory controller 120 may include a buffer memory 121. The flash memory 130 may include a cell array 131 and a page buffer 132. Although not shown in FIG. 1, the flash memory 130 may also include a decoder, a data buffer, and a control unit.

The memory controller 120 may receive data and a writing command from the host 110, and may control the flash memory 130 to write the received data into the cell array 131. Further, the memory controller 120 may operate to control the flash memory 130 to read data from the cell array 131 responsive to a reading command provided from the host 110.

The buffer memory 121 may temporarily store data to be written into and/or read from the flash memory 130. As such, the buffer memory 121 may transfer data to the host 110 or the flash memory 130.

The cell array 131 of the flash memory 130 may include a plurality of memory cells. These memory cells may be nonvolatile in property, and as such, may retain their data without power after storing the data. The page buffer 132 may be used to store data to be written into and/or data read from a selected page.

Memory cells of the flash memory 130 may be classified as a single-level cell (SLC) or a multi-level cell (MLC) based on the number of data bits able to be stored. The SLC may store single-bit data, while the MLC may store multi-bit data.

First, consider a SLC in which a unit cell stores a single data bit. The SLC may be operable in two states according to distribution of threshold voltages. This SLC may store data as a ‘1’ or a ‘0’ after a programming operation. A memory cell storing a ‘1’ may be referred to as being in an erased state, while a memory cell storing a ‘0’ may be referred to as being in a programmed state. A memory cell in the erased state may be called an ‘on-cell’, while a memory cell in the programmed state may be called an ‘off-cell’.

The flash memory 130 may conduct a programming operation one page at a time. The memory controller 120 may transfer data to the flash memory 130 through the buffer memory 121 page-by-page during a programming operation.

The page buffer 132 may temporarily store data loaded from the buffer memory 121, and may program the loaded data into a selected page. After completing the programming operation, a program-verifying operation may be carried out to verify whether the data has been correctly programmed.

Based on results of the program-verifying operation, if a failure is indicated, the programming and program-verifying operations may be repeated with an incremented program voltage. After completely programming data corresponding to one page, the next data may be received for the next programming operation.

Next, consider a MLC in which a unit cell stores multi-bit data. FIG. 2 shows a procedure for programming 2-bit data, i.e., a least significant bit (LSB) and a most significant bit (MSB), into a single memory cell.

Referring to FIG. 2, a memory cell may be programmed to have one of four states 11, 01, 10, and 00 based on the distribution of threshold voltages. A procedure for programming an LSB may be similar to that of the aforementioned SLC mode. A memory cell in the ‘11’ state may be programmed to have a state ‘A’ depicted by a dotted line in accordance with an LSB.

The memory controller 120 may transfer page data (data corresponding to one page) to the flash memory 130 from the buffer memory 121 in order to program an MSB. Referring to FIG. 2, a memory cell in state ‘A’ may be programmed to the ‘00’ state (program1) or the ‘10’ state (program2). Meanwhile, a memory cell having the ‘11’ state may be maintained at the ‘11’ state or programmed to the ‘01’ state (program3) in accordance with an MSB.

FIG. 3 shows an additional procedure for programming 2-bit data. Referring to FIG. 3, a memory cell in the ‘11’ state may be programmed to the ‘10’ state (program1), or to the ‘01’ state (program3). Also, when in the ‘10’ state, the memory cell may be programmed to the ‘00’ state (program2).

Returning to FIG. 1, the memory system 100 may program multi-bit data into the cell array 131 of the flash memory 130 by way of the aforementioned procedure. Namely, multi-bit data may be programmed by programming an LSB and programming an MSB into the memory cell that has been programmed with the LSB.

The MLC may be used to increase storage capacity per area in a memory chip. Although the MLC may increase storage capacity of a memory chip, the speed of the MLC may be less than the SLC for programming and/or reading. For instance, the SLC may be programmed in about 200 μs, while the MLC may be programmed in about 800 μs.

In addition, the error probability of the MLC may be greater than that of the SLC. For example, during a programming operation, an error may be generated while programming an MSB even though there has been no error in programming an LSB. In this case, the LSB data may be inadvertently lost. Especially for data such as security data where data integrity may be important, errors during the programming operation may be problematic. Also, a user may not use the full data storage capacity of a flash memory device. For instance, if an MLC flash memory has storage capacity of 8 Gb (gigabits), some users may use only about 1 Gb.

### SUMMARY OF THE INVENTION

Some embodiments of the present invention provide a memory system operable in an SLC or MLC mode in accordance with selection by a user.

According to some embodiments of the present invention, a memory device includes a flash memory including at least one memory cell configured to store multi-bit data therein, an MLC mode selector configured to generate a mode selection signal indicating whether to store single-bit data or multi-bit data in the memory cell responsive to a user selection, and a memory controller configured to operate the flash memory in a single-level cell (SLC) program mode to store the single-bit data or a multi-level cell (MLC) program mode to store the multi-bit data based on the mode selection signal from the MLC mode selector.

In some embodiments, the flash memory may be configured to store program mode information indicating whether the single-bit data or the multi-bit data is stored therein. The memory controller may be configured to execute a reading operation in the SLC mode or the MLC mode based on the program code information.

In some embodiments, the flash memory may include a memory cell array configured to store the program mode information. For example, the memory cell array of the flash memory may include data and spare fields, and that the program mode information may be stored in a spare field. In other embodiments, the memory cell array of the flash memory may include a plurality of memory blocks, and the program mode information may be stored in one of the plurality of memory blocks.

In some embodiments, the flash memory and the memory controller may be integrated in a memory card. The MLC mode selector may be external to the memory card. For example, the MLC mode selector may be installed in the form of a button or switch on the external surface of the memory card.

In other embodiments, the memory controller may include a control unit configured to control programming of the flash memory in the SLC mode or the MLC mode based on the mode selection signal. The memory controller may further include a buffer memory unit configured to store data to be programmed into the flash memory and/or data read from the flash memory. In some embodiments, flash memory may be a NAND flash memory.

According to other embodiments of the present invention, a memory system includes a memory controller configured to operate a flash memory device in a single-level cell (SLC) program code to store single-bit data in a memory cell thereof or any multi-level cell (MLC) program mode to store multi-bit data in the memory cell based on a mode selection signal generated responsive to a user selection. The memory controller is further configured to store program mode information for the memory cell indicating whether a single-bit data or the multi-bit data is stored therein.

In some embodiments, the flash memory device and the memory controller may be integrated into a memory card. The MLC mode selector may be external to the memory card. For example, MLC mode selector may be a button or a switch on an external surface of the memory card.

In other embodiments, the memory controller may include a control unit configured to control programming of the flash memory device in the SLC mode or the MLC mode based on the mode selection signal, and a buffer memory unit configured to store data to be programmed into the flash memory device and/or data read from the flash memory device. For example, the control unit may include an MLC mode storage unit configured to store the program mode information. The MLC mode storage unit may be an electrically erasable and programmable read-only memory.

In some embodiments, the memory controller may be configured to execute a reading operation in the SLC mode or the MLC mode based on the program mode information.

According to still further embodiments of the present invention, a method of operating a memory device includes generating a mode selection signal indicating whether to store single-bit data or multi-bit data in a memory cell of a flash memory device that is configured to store multi-bit data therein responsive to a user selection. The flash memory device is operated in a single-level cell (SLC) program mode to store the single-bit data or a multi-level cell (MLC) program mode to store the multi-bit data based on the mode selection signal.

In some embodiments, program mode information may be stored for the memory cell indicating whether the single-bit data or the multi-bit data is stored therein. For examples the program mode information may be stored in a memory controller of the flash memory device and/or in the flash memory device itself. A reading operation may be executed in the SLC mode or the MLC mode based on the program mode information.

### BRIEF DESCRIPTION OF THE DRAWINGS

FIG. 1 is a block diagram of a conventional memory system;

FIGS. 2 and 3 are diagrams showing conventional procedures for programming multi-bit data into a memory cell;

FIG. 4 is a block diagram of a memory system according to some embodiments of the present invention;

FIG. 5 is a schematic diagram further illustrating the MLC mode selector shown in FIG. 4 according to some embodiments;

FIG. 6 is a diagram further illustrating the MLC mode selector shown in FIG. 4 according to other embodiments;

FIG. 7 is a block diagram of a memory system according to further embodiments of the present invention; and

FIG. 8 is a block diagram of a memory system according to still further embodiments of the present invention.

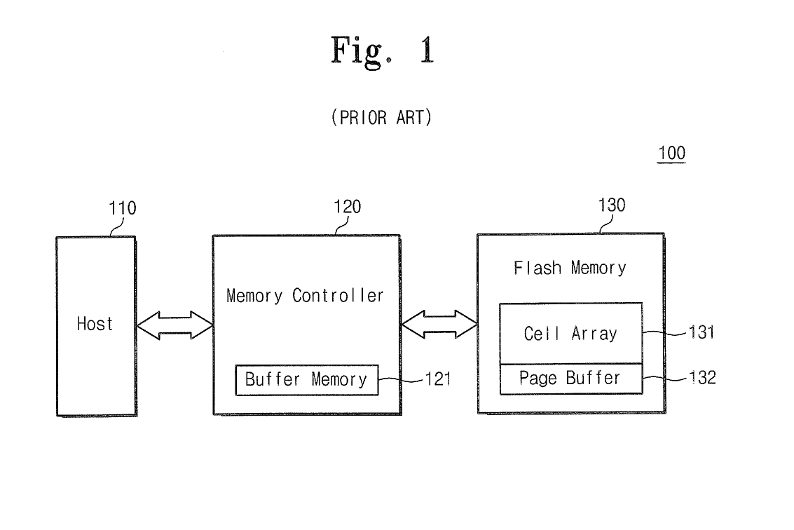

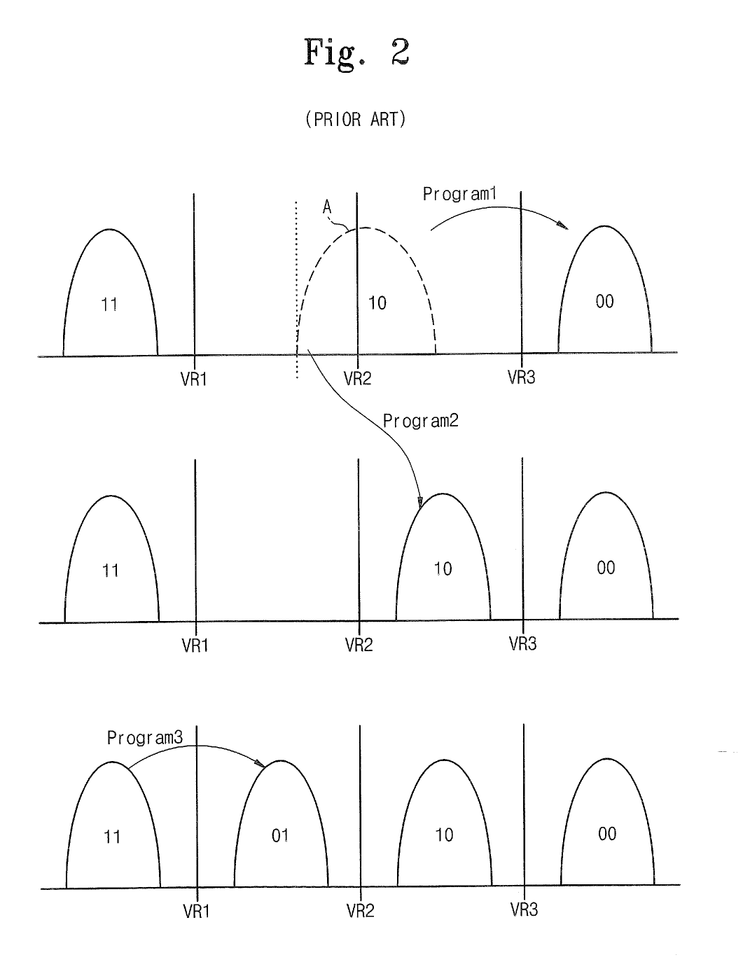

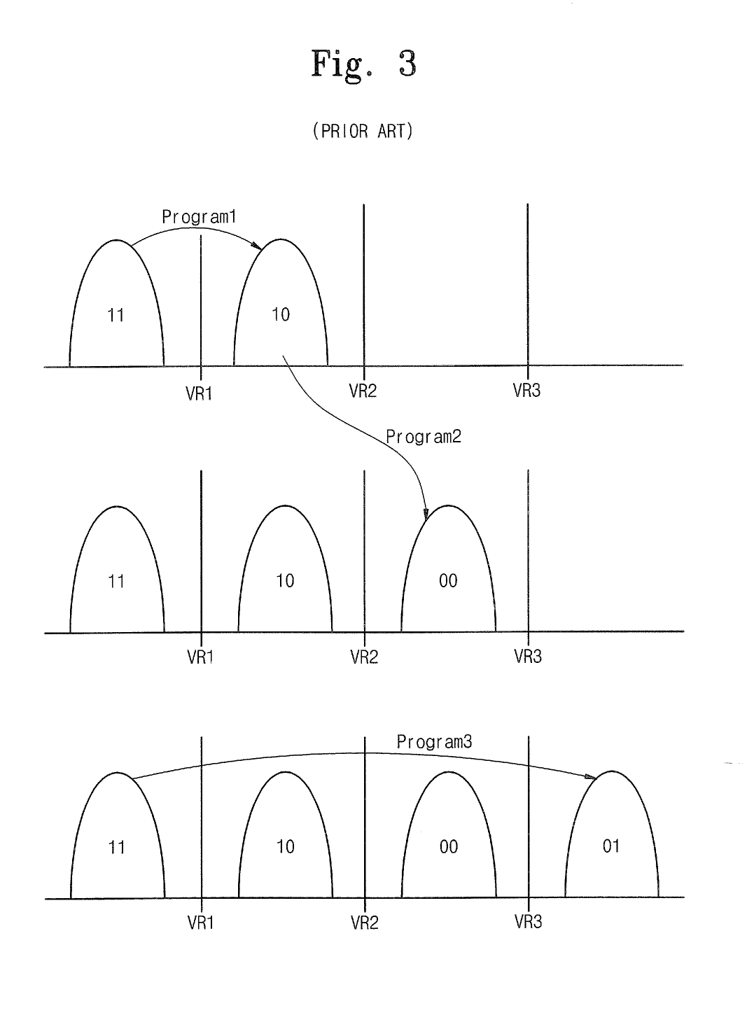

### DETAILED DESCRIPTION OF EMBODIMENTS OF THE INVENTION

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the sizes and relative sizes of layers and regions may be exaggerated for clarity.

It will be understood that when an element is referred to as being “on,” “connected to” or “coupled to” another element, it can be directly on, connected or coupled to the other element or layer or intervening elements may be present. In contrast, when an element is referred to as being “directly on,” “directly connected to” or “directly coupled to” another element, there are no intervening elements present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

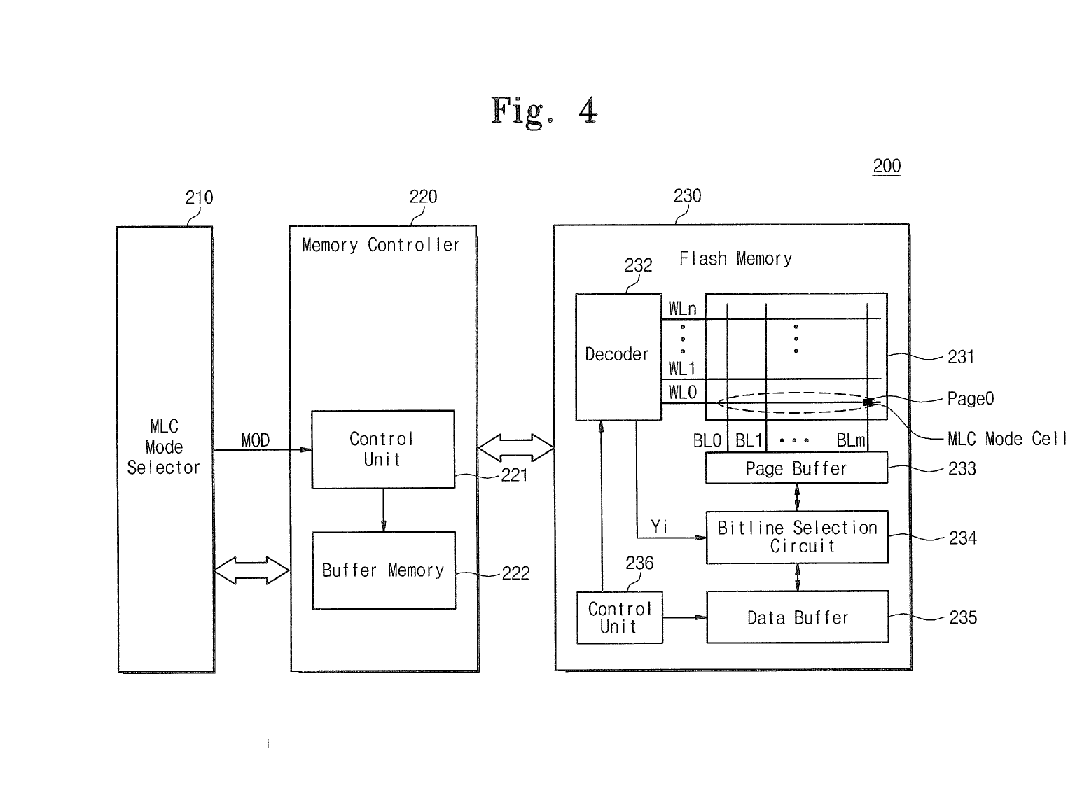

FIG. 4 is a block diagram of a memory system according to some embodiments of the present invention. Referring to FIG. 4, the memory system 200 includes an MLC mode selector 210, a memory controller 220, and a flash memory 230. The flash memory 230 is configured to store multi-bit data in a single (or unit) memory cell.

In FIG. 4, the memory controller 220 and the flash memory 230 may be included in a single memory card. This memory card may be, for example, a MultiMedia Card (MMC), a Secure Digital (SD) card, an eXtreme Digital (XD) card, a CompactFlash (CF) card, or a subscriber identification module (SIM) card. The memory card may be used in connection with a host (not shown) such a personal computer, a notebook or laptop computer, a mobile phone, an MP3 player, and/or a portable multimedia player (PMP).

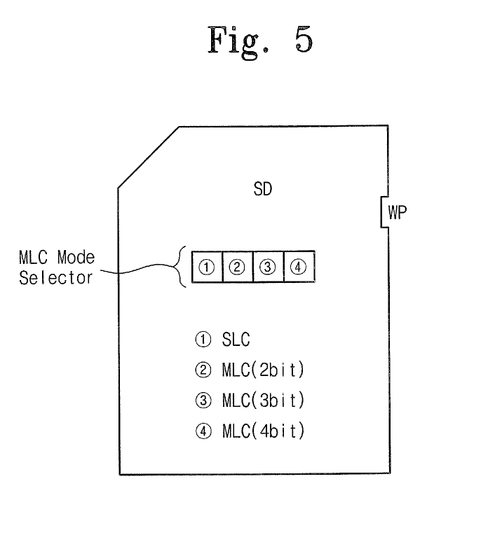

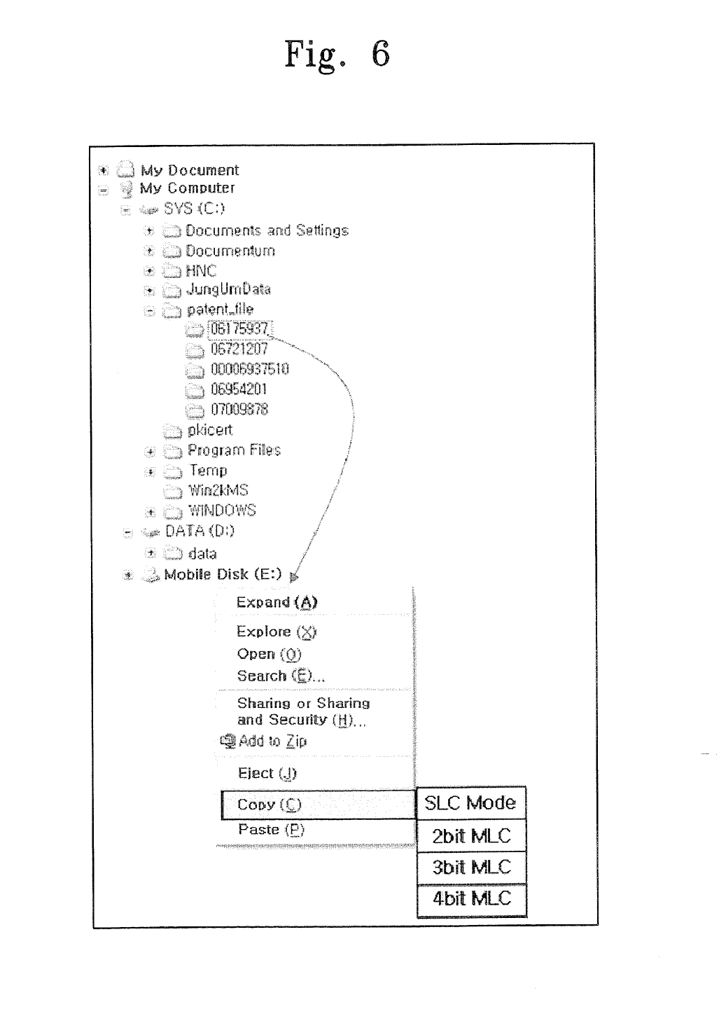

The MLC mode selector 210 functions to select an operation mode (an SLC or MLC mode) for the flash memory 230. As illustrated in FIG. 5, the MLC mode selector 210 may be accessed from a memory card, and/or using a mouse and/or a keyboard connected to a computer system as shown in FIG. 6.

FIG. 5 illustrates an implementation where the MLC mode selector 210 is provided externally to a memory card. Referring to FIG. 5, an SD card includes the MLC mode selector on the outside of the card. The MLC mode selector 210 may be implemented as one or more buttons, and/or as a switch, similar to a write-protection switch. FIG. 5 shows the MLC mode selector implemented in the form of button.

For instance, when a user pushes a button #1, the memory system operates in the SLC mode. When a user pushes a button #2, the memory system operates in a 2-bit MLC mode. When a user pushes a button #3, the memory system operates in a 3-bit MLC mode. When a user pushes a button #4, the memory system operates in a 4-bit MLC mode. While FIG. 5 shows the memory system as an SD card, the present invention may be used in other types of memory cards (e.g., MMC or xD card) in a similar manner.

FIG. 6 illustrates an implementation where the MLC mode selector 210 is provided in the form of a drop-down menu in a computer system which may be accessed using a mouse and/or keyboard. Referring to FIG. 6, when a user wishes to copy a file (e.g., ‘06175937’) into a mobile storage medium (e.g., an SD card), the user can select a program mode of the mobile storage medium (e.g., ‘SLC Mode’, ‘2 bit MLC’, ‘3 bit MLC’, or ‘4 bit MLC’) by means of the mouse and/or keyboard.

Returning to FIG. 4, a user can select the SLC or MLC mode of the flash memory 230 by means of the MLC mode selector 210. In some embodiments, there may be several MLC modes available, e.g., a 2-bit MLC mode capable of storing 2 bits in a unit memory cell, a 3-bit MLC mode capable of storing 3 bits in a unit memory cell, and a 4-bit MLC mode capable of storing 4 bits in a unit memory cell.

The MLC mode selector 210 generates a mode selection signal MOD in response to selection of an operation mode from the user. The mode selection signal MOD is provided to the control unit 221. The control unit 221 operates to control the flash memory 230 in the SLC or MLC mode based on the mode selection signal MOD.

The memory controller 220 operates to control overall functions (e.g., writing and reading operations) of the flash memory 230. Referring to FIG. 4, the memory controller 220 includes the control unit 221, and a buffer memory 222. The control unit 221 operates to control the buffer memory 222 and the flash memory 230 in accordance with an input command. The control unit 221 receives the mode selection signal MOD from the MLC mode selector 210 and controls a program mode of the flash memory 230.

The buffer memory 222 is used to store data to be written into the flash memory 230 and/or data read from the flash memory 230. Data stored in the buffer memory 222 may be transferred to the flash memory 230 or a host (not shown) by the control unit 221. The buffer memory 222 may be implemented as random access memory (RAM), e.g., a static or dynamic RAM.

Still referring to FIG. 4, the flash memory 230 includes a cell array 231, a decoder 232, a page buffer 233, a bit-line selection circuit 234, a data buffer 235, and a control unit 236. FIG. 4 illustrates a NAND flash memory by way of example; however, other flash memory types may also use selectable program modes according to some embodiments of the present invention.

The cell array 231 includes a plurality of memory blocks (not shown). Each memory block includes a plurality of memory pages (for example, 32 pages). Each page includes a plurality of memory cells (for example, 512 or 2K Bytes). In NAND flash memory, an erasing operation is carried out a block at a time, while reading and writing operations are carried out one page at a time.

When storing 2-bit data in a unit memory cell, each memory cell has four states or levels based on the distribution of threshold voltages. Hereinafter will be described a case of storing 2-bit data in a unit memory cell. However, embodiments of the present invention may be used for storing multi-bit data of more than 2 bits (e.g., 3 or 4 bits) in a unit memory cell.

Each page may be operable in the SLC or MLC mode based on the mode selection signal MOD. As such, a unit memory cell of one page may store single-bit data or multi-bit data (e.g., 2-bit data). A page may include one or more MLCs. In FIG. 4, a selected page Page0 includes a single MLC (marked by a black dot). This MLC (also referred to herein as the MLC mode cell) stores information about a program mode (also referred to herein as program mode information) for the selected page Page0, i.e., the SLC or MLC mode.

The cell array 231 may be divided into data and spare fields. If a unit page size is 528 Bytes, 512 Bytes are stored in the data field while 16 Bytes are stored in the spare field. The MLC mode cell is included in the spare field. The flash memory 230 stores information about a program mode of the selected page Page0 in the MLC mode cell of the spare field during a programming operation. The flash memory 230 executes a reading operation in the SLC or MLC mode in accordance with the program mode information set in the MLC mode cell.

The decoder 232 is connected to the cell array through word lines WL0˜WLn, being operated by the control unit 236. The decoder 232 receives an address ADDR from the memory controller 220 and generates a selection signal Yi to designate a word line (e.g., WL0) and/or a bit line (BL). The page buffer 233 is connected to a cell array 231 through the bit lines BL0˜BLm.

The page buffer 233 stores data loaded from the buffer memory 222. Data for one page is loaded into the page buffer 233. The loaded data is programmed in a selected page (e.g., Page0) during a programming operation. In addition, the page buffer 233 reads data from the selected page Page0 during a reading operation, and temporarily stores the read data therein. Data stored in the page buffer 233 is transferred to the buffer memory 222 in response to a read-enable signal nRE (not shown).

The bit-line selection circuit 234 is configured to select a bit line in response to the selection signal Yi. The data buffer 235 functions as an input/output buffer used for data transmission between the memory controller 220 and the flash memory 230. The control unit 236 receives a control signal from the memory controller 220, controlling internal operations of the flash memory 230.

Accordingly, the memory system 200 according to some embodiments of the present invention includes an MLC mode selector 223. The MLC mode selector 223 generates a mode selection signal MOD in response to selection by a user. The control unit 221 enables the flash memory 230 to be programmed in the SLC or MLC mode in accordance with the mode signal MOD. The flash memory 230 stores information about the program mode (an SLC or MLC mode) in the spare field of the selected page Page0 during a programming operation, and conducts a reading operation in accordance with the stored mode information.

Thus, memory systems according to some embodiments of the present invention may be configured to store data in either the SLC or MLC mode. As such, a user can increase programming speed and/or reduce error probability at the expense of a data capacity and/or security.

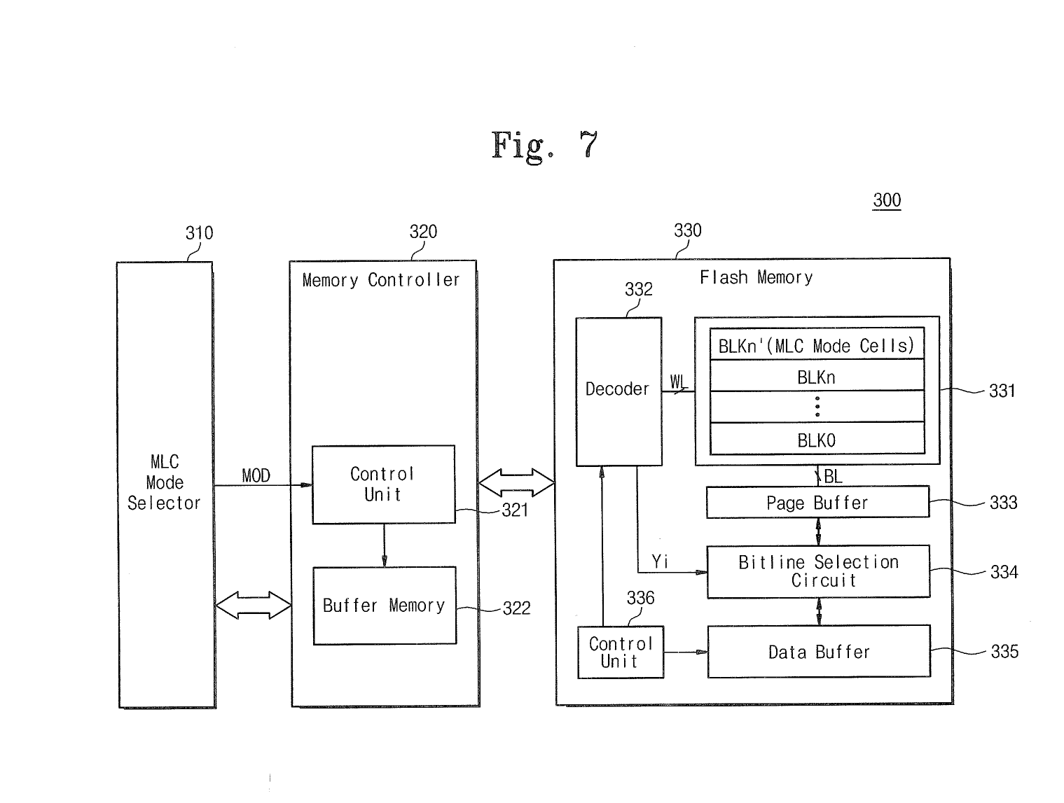

FIG. 7 is a block diagram of a memory system according to other embodiments of the present invention. Referring to FIG. 7, the memory system 300 includes an MLC mode selector 310, a memory controller 320, and a flash memory 330. The memory controller 320 includes a control unit 321, and a buffer memory 322. The functionality of these elements may be similar to the corresponding elements described above with reference to FIG. 4, and as such, further description of these elements will be omitted.

Referring to FIG. 7, the cell array 231 includes a plurality of memory blocks BLK0˜BLKn and BLKn′. Each memory block includes a plurality of pages (not shown). Each page is operable in the SLC or MLC mode in accordance with the mode selection signal MOD. More particularly, each memory cell of a page stores single-bit data or multi-bit data (e.g., 2 bits) in response to the mode selection signal MOD.

One or more of the plurality of memory blocks, BLKn′, includes at least one MLC. As shown in FIG. 7, information about a program mode is stored in the specific memory block BLKn′, not in the spare field of each page. In other words, the flash memory 330 stores all information about a program mode (the SLC or MLC mode) for a selected page (e.g., Page0; see FIG. 4) in the specific memory block BLKn. As such, the flash memory 330 conducts a reading operation in the SLC or MLC mode based on the program mode information stored in the specific memory block BLKn′.

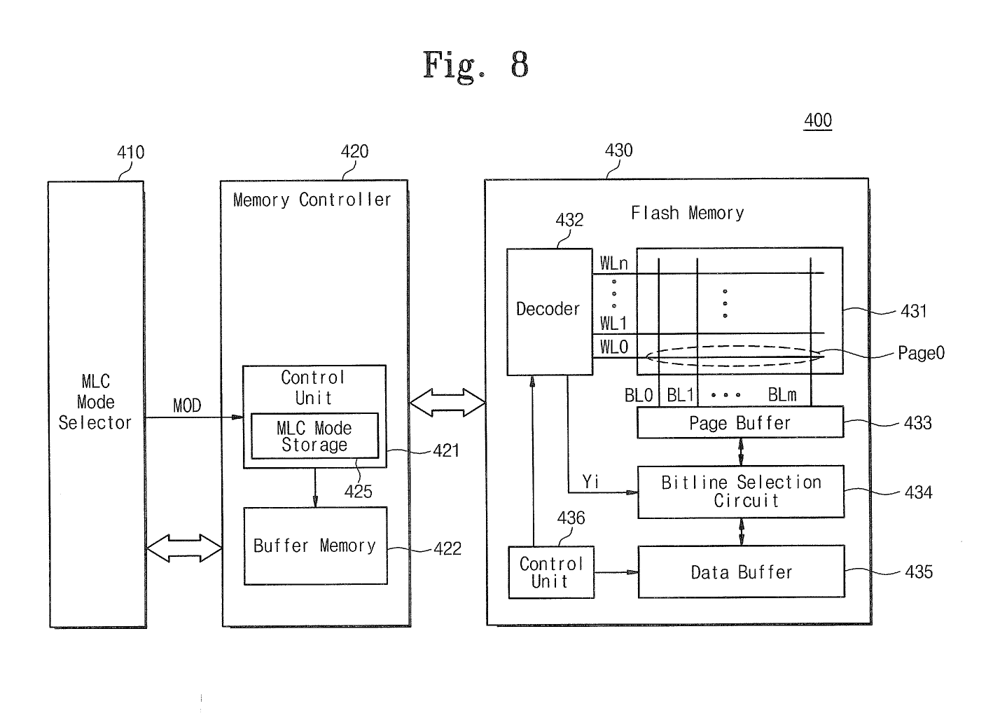

FIG. 8 is a block diagram of a memory system according to still other embodiments of the present invention. Referring to FIG. 8, the memory system 400 includes an MLC mode selector 410, a memory controller 420, and a flash memory 430. The memory controller 420 includes a control unit 421, and a buffer memory 422.

Referring to FIG. 8, the control unit 421 includes an MLC mode storage unit 425. The MLC mode storage unit 425 stores information about the program mode (the SLC or MLC mode). More particularly, the memory controller 420 stores information about the program mode (the SLC or MLC mode) for a selected page (e.g., Page0) in the MLC mode storage unit 425 of the control unit 421 of the memory controller 420. As such, the memory controller 420 conducts a reading operation of the flash memory 430 in the SLC or MLC mode in accordance with the program mode information stored in the MLC mode storage unit 425. The MLC mode storage unit 425 may be implemented as a register, and/or as an electrically erasable and programmable read-only memory (EEPROM).

As stated above, in some embodiments of the present invention, a user may determine a program mode of the flash memory. As such, a user may choose to enhance a programming speed and reduce data error rate by selecting the SLC mode, or to extend data capacity by selecting the MLC mode, for example, based on the characteristics (i.e., size or importance) of the particular data to be stored.

In summary, according to some embodiments of the present invention, a user can select a program mode of a flash memory. As such, some embodiments of the present invention may allow the user to choose a faster programming operation with reduced data errors by selecting the SLC mode, or to choose increased data capacity by selecting the MLC mode(s), based on particular data characteristics.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

That which is claimed:

1. A memory device comprising:
a flash memory including at least one memory cell configured to store multi-bit data therein;
an MLC mode selector configured to generate a mode selection signal indicating whether to store single-bit data or multi-bit data in the memory cell responsive to a user selection; and
a memory controller configured to operate the flash memory in a single-level cell (SLC) program mode to store the single-bit data or a multi-level cell (MLC) program mode to store the multi-bit data based on the mode selection signal from the MLC mode selector.

2. The memory device of claim 1, wherein the flash memory is configured to store program mode information for the memory cell indicating whether the single-bit data or the multi-bit data is stored therein, and wherein the memory controller is configured to execute a reading operation in the SLC mode or the MLC mode based on the program mode information.

3. The memory device of claim 2, wherein the flash memory comprises a memory cell array configured to store the program mode information.

4. The memory device of claim 3, wherein the memory cell array comprises data fields and spare fields, and wherein the program mode information is stored in a spare field of the memory cell array.

5. The memory device of claim 3, wherein the memory cell array comprises a plurality of memory blocks, and wherein the program mode information is stored in one of the plurality of memory blocks.

6. The memory device of claim 1, wherein the flash memory and the memory controller are integrated in a memory card.

7. The memory device of claim 6, wherein the MLC mode selector comprises a button on an external surface of the memory card.

8. The memory device of claim 6, wherein the MLC mode selector comprises a switch on an external surface of the memory card.

9. The memory device of claim 1, wherein the memory controller comprises:
a control unit configured to control programming of the flash memory in the SLC mode or the MLC mode based on the mode selection signal; and
a buffer memory unit configured to store data to be programmed into the flash memory and/or data read from the flash memory.

10. The memory device of claim 1, wherein the flash memory comprises NAND-type flash memory.

11. A memory system comprising:
a memory controller configured to operate a flash memory device in a single-level cell (SLC) program mode to store single-bit data in a memory cell thereof or in a multi-level cell (MLC) program mode to store multi-bit data in the memory cell based on a mode selection signal generated responsive to a user selection, wherein the memory controller is further configured to store program mode information for the memory cell indicating whether the single-bit data or the multi-bit data is stored therein.

12. The memory system of claim 11, further comprising the flash memory device, wherein the flash memory device and the memory controller are integrated in a memory card.

13. The memory system of claim 12, further comprising:
an MLC mode selector configured to generate the mode selection signal that indicates whether to store the single-bit data or the multi-bit data in the memory cell responsive to the user selection,
wherein the MLC mode selector is external to the memory card.

14. The memory system of claim 13, wherein the MLC mode selector comprises a button on an external surface of the memory card.

15. The memory system of claim 13, wherein the MLC mode selector comprises a switch on an external surface of the memory card.

16. The memory system of claim 11, wherein the memory controller comprises:
a control unit configured to control programming of the flash memory device in the SLC mode or the MLC mode based on the mode selection signal; and
a buffer memory unit configured to store data to be programmed into the flash memory device and/or data read from the flash memory device.

17. The memory system of claim 16, wherein the control unit comprises an MLC mode storage unit configured to store the program mode information.

18. The memory system of claim 17, wherein the MLC mode storage unit comprises an electrically erasable and programmable read-only memory.

19. The memory system of claim 11, wherein the memory controller is configured to execute a reading operation in the SLC mode or the MLC mode based on the program mode information.

20. The memory system of claim 12, wherein the flash memory device comprises a NAND flash memory card.

21. A method of operating a memory device, the method comprising:
generating a mode selection signal indicating whether to store single-bit data or multi-bit data in a memory cell of a flash memory device that is configured to store multi-bit data therein responsive to a user selection; and
operating the flash memory device in a single-level cell (SLC) program mode to store the single-bit data or a multi-level cell (MLC) program mode to store the multi-bit data based on the mode selection signal.

22. The method of claim 21, further comprising:
storing program mode information for the memory cell indicating whether the single-bit data or the multi-bit data is stored therein.

23. The method of claim 22, further comprising:
executing a reading operation in the SLC mode or the MLC mode based on the program mode information.
